(19) United States
(12) Patent Application Publication
(10) Pub. No.: US 2015/0337981 A1
(43) Pub. Date: Nov. 26, 2015

(54) VALVE CONTROLLER

(71) Applicants: Justin Miller, Milwaukee, WI (US); Jeff Rogala, Delafield, WI (US)

(72) Inventors: Justin Miller, Milwaukee, WI (US); Jeff Rogala, Delafield, WI (US)

(73) Assignee: TLX TECHNOLOGIES, LLC, Pewaukee, WI (US)

(21) Appl. No.: 14/716,648

(22) Filed: May 19, 2015

Related U.S. Application Data
(60) Provisional application No. 62/001,440, filed on May 21, 2014.

(51) Int. Cl. F16K 31/08; F16K 31/06

(52) U.S. Cl. CPC F16K 31/082; F16K 31/0672; F16K 31/0675

(57) ABSTRACT

A valve controller is provided. The valve controller includes an armature formed by a moving armature and an armature pin. The moving armature movable from a latched position in which it is decoupled from the armature pin and in contact with a core, to an unlatched position where it is decoupled from the core and in contact with the armature pin.

### CROSS-REFERENCE TO RELATED PATENT APPLICATIONS

This patent application claims the benefit of U.S. Provisional Patent Application No. 62/001,440, filed May 21, 2014, the entire teachings and disclosure of which are incorporated herein by reference thereto.

### FIELD OF THE INVENTION

The present invention relates generally to solenoids, and more particularly to a valve controller including a solenoid having an armature held in place by a magnetic latch independent of pressure without drawing any current in the solenoid.

### BACKGROUND OF THE INVENTION

Magnetically latching solenoids are generally recognized as providing a low energy consumption alternative to constant current solenoid devices. In such constant current solenoid devices, a constant electrical current is required to be supplied to a winding to generate enough force to hold the armature of the solenoid in a desired position. When this current is removed, the armature is then returned to its default state, typically by way of a biasing member such as a spring connected to the armature.

In contrast, a latching solenoid need only momentarily have electrical current applied thereto to overcome a magnetic attraction of the armature to another structure, often referred to as a pole piece. This magnetic attraction is provided by a permanent magnet situated in the latching solenoid, which continually generates a magnetic field. When electrical current is applied in one direction to a winding of the solenoid, the magnetic field strength is reduced until the magnetic attraction between the pole piece and armature is not as strong as an opposing force provided by a biasing member, typically a spring, connected to the armature and arranged to bias the armature away from the pole piece.

Once this magnetic attraction is overcome, the electrical current is no longer applied, and the armature is moved from its latched position, to an unlatched position. To return the armature to the latched position, electrical current is again momentarily applied, this time in the opposite direction, to increase the magnetic field generated by the permanent magnet such that the force provided by the biasing element is not as strong as the magnetic attraction between the pole piece and the armature. The armature then returns to the latched position and is ready for a subsequent duty cycle.

In certain applications, however, the armature is exposed to an external load in the latched position. This may for example be an external pressure acting on a valve member to which the armature is attached. As such, the force required to move the armature from the latched to the unlatched position not only must be enough to overcome the magnetic attraction between the pole piece and armature, but also the force as a result of the pressure acting on the armature in the latched position. In such configurations, there is thus an increased energy requirement to unlatch the device.

Further, latching solenoids typically employ a one-piece armature or an armature assembly that has a relatively large mass and moves as a single unit through all phases of actuation. Such a configuration has a reduced shock load resistance.

As such, there is a need in the art for a latching solenoid which has a reduced unlatching force than those typical designs described above, while also offering an increase in shock load resistance.

The invention provides such a device. The device of the present disclosure must also be of construction which is both durable and long lasting, and it should also require little or no maintenance to be provided by the user throughout its operating lifetime. In order to enhance the market appeal of the valve controller, it should also be of inexpensive construction to thereby afford it the broadest possible market. Finally, it is also an objective that all of the aforesaid advantages and objectives be achieved without incurring any substantial relative disadvantage.

These and other advantages of the invention, as well as additional inventive features, will be apparent from the description of the invention provided herein.

### BRIEF SUMMARY OF THE INVENTION

There is disclosed a valve controller configured to close a valve coupled to the valve controller. The valve controller includes a solenoid including a two-piece decoupled armature configured for high shock load resistance by reducing the mass of the armature moving parts. Radially positioned magnets increase the shock load resistance of the armature.

The two-piece armature, armature and armature pin, allows the valve to which the solenoid is coupled to be decoupled from the force of pressure acting on the pin. The delatch force is independent of the pressure force. An additional benefit of the two-part armature configuration is that the armature has more stroke than the actuation pin which increases the shock load resistance to change from spring loaded to magnetically latched.

The valve controller includes a solodyne housing with an electric coil winding disposed in the housing with the coil winding defining a central opening. A ferrous core is disposed in the central opening, the ferrous core defining a recess. A biasing device is configured to store a biasing force and is disposed in the recess.

A moving armature is aligned with the ferrous core and is in operative contact with the biasing device. A circular, permanent magnet is coupled to the solenoid housing and configured to magnetically couple with the moving armature with a magnetic force. The circular permanent magnet can be a single ring of magnetic material or it can be a segmented ring. The circular permanent magnet that is segmented, may have two semi-circular segments, four arc segments or six arc segments as determined by the user.

A retainer is coupled to the permanent magnet with the retainer defining a central through orifice. The retainer is configured to receive a portion of the moving armature. A diaphragm is coupled to the retainer, with the diaphragm configured to selectively close the valve. An armature pin is disposed in the through orifice a spaced distance from the moving armature and configured to more in the through orifice when the biasing force of the biasing device exceeds the magnetic force and the biasing device pushes the moving armature against the armature pin to extent a portion of the armature pin beyond an edge of the retainer against the diaphragm to close the valve.

In another embodiment of the valve controller, the biasing device is a coil spring.

The circular permanent magnet exerts a magnetic force that exceeds the biasing device stored energy when the valve controller is in a latched state. In the latched state, the valve is in an open condition. When the valve controller is in an unlatched state, the permanent magnetic force is less than the biasing device stored energy and the moving armature pushes the armature pin against the diaphragm to close the valve.

In another embodiment, a ferrous washer is disposed between the electric coil winding and the permanent magnetic wherein the coil winding and the permanent magnet are magnetically coupled together.

There is further provided a method for increasing shock load resistance in a valve controller coupled to a valve. The method includes providing the valve controller with a moving aperture. The moving aperture is coupled to the valve controller with a circular permanent magnet. The moving aperture is moveably independent of a ferrous core of the valve controller and moveably independent of an armature pin of the valve controller. The moving armature is configured to move further than the armature pin to close the valve.

In another embodiment, the method includes configuring the circular permanent magnet as one of two arc segments, four arc segments, and six arc segments. In another embodiment, the method includes inserting a ferrous washer between the electric coil winding and the permanent magnet, to magnetically couple the electrical winding and permanent magnet together.

The apparatus of the present invention is of a construction which is both durable and long lasting, and which will require little or no maintenance to be provided by the user throughout its operating lifetime. The apparatus of the present invention is also of inexpensive construction to enhance its market appeal and to thereby afford it the broadest possible market.

Finally, all of the aforesaid advantages and objectives are achieved without incurring any substantial relative disadvantage. Such an apparatus should be of construction which is both durable and long lasting, and it should also require little or no maintenance to be provided by the user throughout its operating lifetime. In order to enhance the market appeal of such an apparatus, it should also be of inexpensive construction to thereby afford it the broadest possible market. Finally, the advantages of such an apparatus should be achieved without incurring any substantial relative disadvantage.

Other aspects, objectives and advantages of the invention will become more apparent from the following detailed description when taken in conjunction with the accompanying drawings.

### DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an exploded, perspective illustration of an exemplary embodiment of a valve controller.

FIG. 2 is a cross-section of the valve controller illustrated in FIG. 1 coupled to a valve, with the valve in an open condition and the valve controller in a latched state.

FIG. 3 is a cross-section of the valve controller illustrated in FIG. 2, with the valve in a closed condition and the valve controller in an unlatched state.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

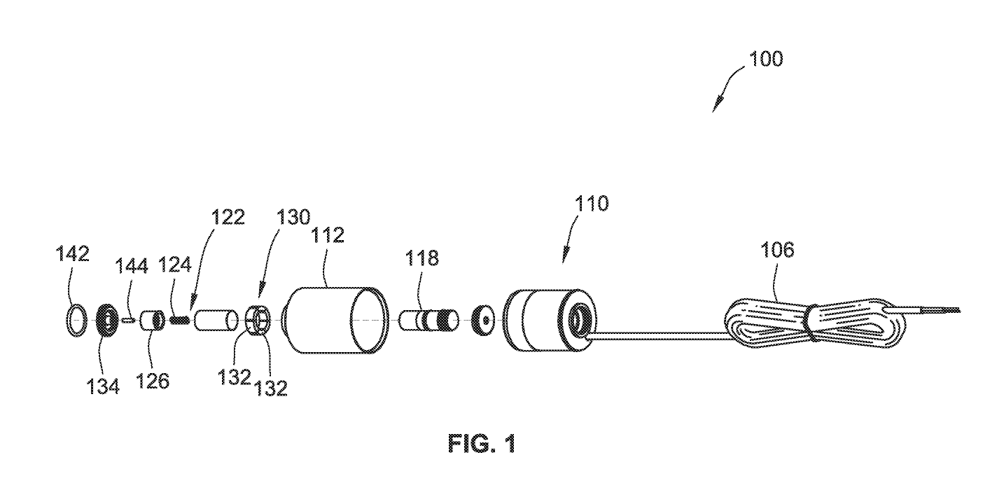

An exemplary embodiment of a valve controller 100 is illustrated in FIGS. 1-3. The valve controller is also referred to as a latching diaphragm pilot valve. The valve controller 100 is configured to close a valve 108 coupled to the valve controller.

The valve controller 100 includes a solenoid housing 112 with an electric coil winding 114 disposed in the housing with the coil winding 114 defining a central opening 116. A ferrous core 118 is disposed in the central opening 116, the ferrous core defining a recess 120. The ferrous core is composed of a magnetic metal which is magnetically affected by the electric coil winding 114.

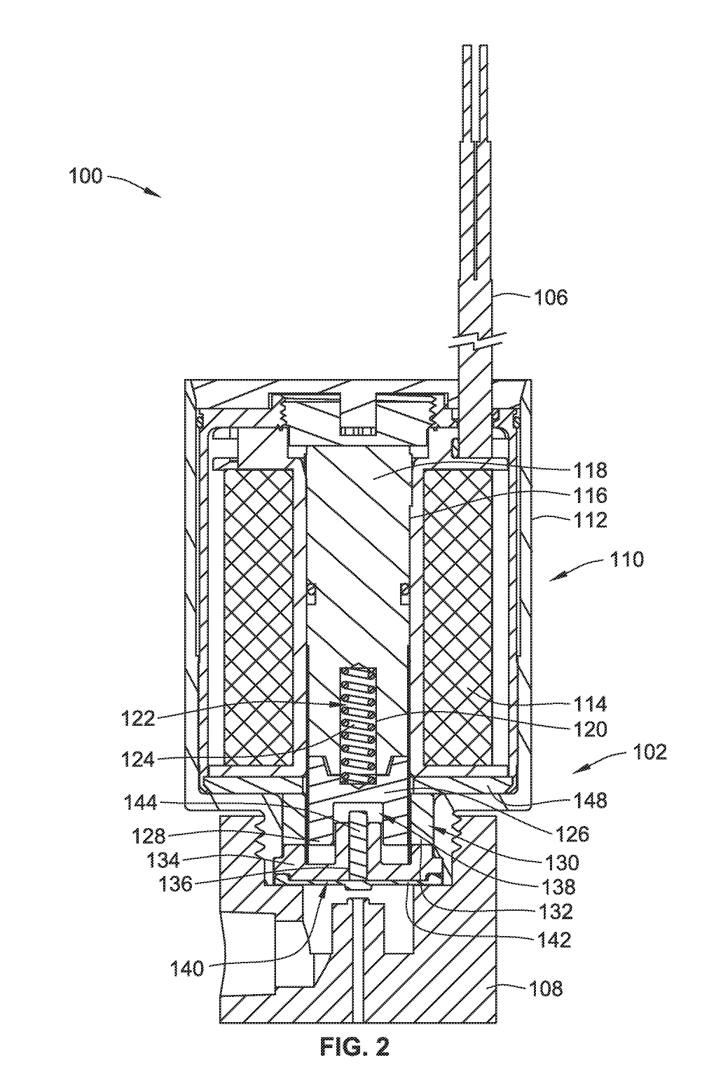

A biasing device 122, for example a coil spring 124, is configured to store a biasing force and is disposed in the recess 120. A moving armature 126 is aligned with the ferrous core 118 and is in operative contact with the biasing device 122. The moving armature 126 is configured to receive the biasing device 122 and is also configured to receive an armature pin 144. The moving armature 126 has recesses formed on opposed axial faces thereof. The upper recess shown in FIG. 2 receives a portion of the core 118 in the latched position. The lower recess shown in FIG. 2 receives a portion of a retainer 134 discussed below and the armature pin 144 in the latched position.

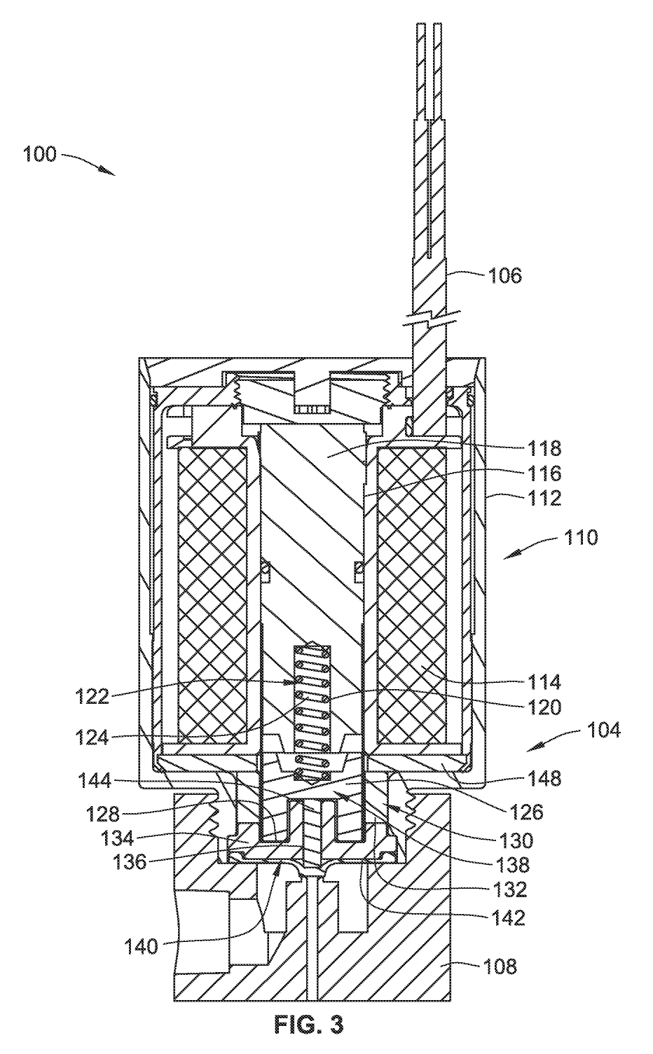

The valve controller also includes a circular permanent magnet 130 coupled to the solenoid housing and configured to magnetically couple with the moving armature 126 with a magnetic force. The circular permanent magnet 130 can be a single circular magnet or it can be configured as one of two arc segments, four arc segments, and six arc segments. It should be understood that the circular permanent magnet 130 can be composed of any number of arc segments 132 as are convenient or appropriate for a given application. FIG. 1 illustrates a six segment 132 circular permanent magnet 130. FIGS. 2 and 3 illustrate a four arc segment 132, circular permanent magnet 130 (two of the arc segments 132 are not shown because of the cross-section).

A retainer 134 is coupled to the permanent magnet, with the retainer 134 defining a central through orifice 136. The retainer 134 is configured to receive a portion 128 of the moving armature 126. The retainer 134 is also configured to receive and retain a diaphragm 142. The diaphragm 142 is configured to selectively close the valve 108. The diaphragm is composed of a material that is flexible and suitable for use with a fluid flowing in the valve 108. An example of diaphragm material is EDPM Rubber. The retainer 134 is composed of non-ferrous material, for example nylon or plastic.

The armature pin 144 is disposed in the through orifice 136 a spaced distance from the moving armature 126 and is coaxially aligned therewith. The armature pin 144 is configured to move in the through orifice 136 when the biasing force of the biasing device 122 exceeds the magnetic force of the circular permanent magnet 130 and the biasing device 122 pushes the moving armature 126 against the armature pin 144. Such movement extends a portion 146 of the armature pin 144 beyond the edge of the retainer 134 against the diaphragm 142 to close the valve 108. The strength of the biasing force and the magnetic force is based on the specific use or application of the valve controller 100 and valve 108.

FIG. 2 illustrates the valve controller 180 in a latched state 102 with the permanent magnet force exceeding the biasing device stored energy. The moving armature 126 is forced against the biasing device 122 by the magnetic force of the circular permanent magnet 130. The moving armature 126 is separate from, i.e. decoupled from, the armature pin 144 as illustrated in FIG. 2. In the latched state 102 there is no pressure force acting on the moving armature 126 because the armature pin 144 is separated from the armature 126. Put differently, an external force acting on armature pin 144, e.g. a force as a result of the pressure within the valve 108 is not transferred to the moving armature 126 as these components are not in contact with one another.

Such a configuration also has the advantage of reducing the delatching force required to decouple the moving armature 126 from the core, as it is independent from the aforementioned force acting on the armature pin 144. One end of the armature pin 144 is resting on the diaphragm 142. In the latched state 102, as illustrated in FIG. 2, the valve 108 is open to allow a fluid to flow.

FIG. 3 illustrates the valve controller 100 in an unlatched state 104. In this unlatched stated 104, the permanent magnetic force is less than the biasing device stored energy. In the unlatched state the moving armature 126 and the armature pin 144 are coupled by the spring force which, for example can be 175 PSI acting on the armature pin 144.

The moving armature 126 and the separate armature pin 144 reduces the overall mass of the device thereby increasing the shock load resistance of the valve controller. In this configuration, the moving armature 126 travels further than the armature pin 144 which facilitates reduced shock loading in the unlatched state 104 of the valve controller 100 by decoupling the pressure load on the armature pin 144. Providing the circular permanent magnet 130 with a plurality of segments radially positioned around the moving armature 126 also increases shock load resistance of the valve controller.

In certain prior designs and as introduced above, an armature and armature pin may be joined together by a press fit forming a unitary assembly, thereby increasing the overall mass of the moving parts. By separating the armature 126 from the armature pin 144 allows the valve 108 to decouple from force of pressure acting on the armature pin 144 since the force pressure acting on the pin is independent of the pressure force exerted on the diaphragm 142 with the valve 108 in an open condition. As shown in FIG. 3, in the unlatched state 104 the biasing device, the coil spring illustrated, pushes against the moving armature 126 which in turn pushes the armature pin 144 against the diaphragm 142 to close the valve 108.

In some embodiments of the valve controller 100, a ferrous washer 148 is disposed between the electric coil winding 114 and the permanent magnet 130. The electric coil winding 114 and the permanent magnet 130 are then magnetically coupled together.

The valve controller 100 is coupled to a controller that selectively energizes the electric coil winding 114 as determined by a user for a specific application. The controller can be coupled to the valve controller by a hard-wire connection 106 or wirelessly. The controller may be a microprocessor coupled to the various apparatus of the system. The controller may also be a server coupled to an array of peripherals or a desktop computer, or a laptop computer, or a smart-phone. It is also contemplated that the controller is configured to control an individual valve controller 100 and may be remote from any of the apparatus. Communication between the controller and the valve controller 100 may be either by hardwire or wireless devices. A memory/data base coupled to the controller may be remote from the controller. The controller typically includes an input device, for example a mouse, or a keyboard, and a display device, for example a monitor screen or a smart phone. Such devices can be hardwired to the controller or connected wirelessly with appropriate software, firmware, and hardware. The display device may also include a printer coupled to the controller. The display device may be configured to mail or fax reports as determined by a user. The controller may be coupled to a network, for example, a local area network or a wide area network, which can be one of a hardwire network and a wireless network, for example a Bluetooth network or internet network, for example, by a WIFI connection or “cloud” connection.

There is also disclosed a method for increasing shock load resistance in a valve controller 100 coupled to a valve 108. The method includes providing the valve controller 100 with a moving armature 126. The moving armature 126 is coupled to the valve controller 100 with a circular permanent magnet 130. The moving armature 126 is moveably independent of a ferrous core 118 of the valve controller 100 and moveably independent of an armature pin 144. The moving armature 126 is configured to move further than the armature pin 144 to close the valve 108.

The method may also include configuring the circular permanent magnet 130 as one of multiple segments 132, for example two arc segments, four arc segments, or six arc segments. It is also contemplated that the method may include inserting a ferrous washer between a ferrous washer 148 between the electric coil winding 114 and the permanent magnet 130, to magnetically couple the electric coil winding 114 and the permanent magnet 130 together.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

Although the foregoing description of the present valve disclosure has been shown and described with reference to particular embodiments and applications thereof, it has been presented for purposes of illustration and description and is not intended to be exhaustive or to limit the valve controller to the particular embodiments and applications disclosed. It will be apparent to those having ordinary skill in the art that a number of changes, modifications, variations, or alterations to the valve controller as described herein may be made, none of which depart from the spirit or scope of the present disclosure. The particular embodiments and applications were chosen and described to provide the best illustration of the principles of the valve controller and its practical application to thereby enable one of ordinary skill in the art to utilize the controller in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A valve controller configured to close a valve coupled to the valve controller, the valve controller comprising:
a solenoid housing;
an electric coil winding disposed in the housing with the coil winding defining a central opening;
a ferrous core disposed in the central opening, the ferrous core defining a recess;
a biasing device configured to store a biasing force and disposed in the recess;
a moving armature aligned with the ferrous core and in operative contact with the biasing device;
a circular permanent magnet coupled to the solenoid housing and configured to magnetically couple with the moving armature with a magnetic force;
a retainer coupled to the permanent magnet, the retainer defining a central through orifice, with the retainer configured to receive a portion of the moving armature
a diaphragm coupled to the retainer, the diaphragm configured to selectively close the valve; and
an armature pin disposed in the through orifice a spaced distance from the moving armature and configured to move in the through orifice when the biasing force of the biasing device exceeds the magnetic force and the biasing device pushes the moving armature against the armature pin to extend a portion of the armature pin beyond an edge of the retainer against the diaphragm to close the valve.

2. The valve controller of claim 1, wherein the biasing device is a coil spring.

3. The valve controller of claim 1, wherein the permanent magnet magnetic force exceeds the biasing device stored energy when the valve controller is in a latched state.

4. The valve controller of claim 1, wherein the permanent magnet magnetic force is less than the biasing device stored energy when the valve controller is in an unlatched state.

5. The valve controller of claim 1, further comprising, the circular permanent magnet configured as one of two arc segments, four arc segments, and six arc segments.

6. The valve controller of claim 1 further comprising a ferrous washer disposed between the electric coil winding and the permanent magnet, wherein the coil winding and permanent magnet are magnetically coupled together.

7. A method increasing shock load resistance in a valve controller coupled to a valve, with the valve controller including an electric coil winding, the method comprising:
providing the valve controller with a moving armature;
coupling the moving armature to the valve controller with a circular permanent magnet, with the moving armature moveably independent of a ferrous core of the valve controller and moveably independent of an armature pin of the valve controller; and
configuring the moving armature to move further than the armature pin to close the valve.

8. The method of claim 7, including configuring the circular permanent magnet as one of two arc segments, four arc segments, and six arc segments.

9. The method of claim 7, including inserting a ferrous washer between the electric coil winding and the permanent magnet, to magnetically couple the electric coil winding and permanent magnet together.

10. A valve controller configured to close a valve coupled to the valve controller, the valve controller comprising:
a solenoid housing;
an electric coil winding disposed in the housing with the coil winding defining a central opening;
a core disposed in the central opening;
a moving armature aligned with the core, the moving armature having a latched and an unlatched position;
a biasing device interposed between the moving armature and the core;
a permanent magnet coupled to the solenoid housing and arranged to apply a magnetic force to the moving armature;
an armature pin coaxially arranged relative to the moving armature; and
wherein the moving armature and armature pin are decoupled from one another in the latched position of the moving armature such that an unlatching force required to transition the moving armature from the latched position to the unlatched position is independent of a force acting on the armature pin in the latched position.

11. The valve controller of claim 10, wherein the biasing device is a coil spring.

12. The valve controller of claim 10, wherein the permanent magnet magnetic force exceeds a biasing force provided by the biasing device when the valve controller is in the latched position.

13. The valve controller of claim 10, wherein the permanent magnet magnetic force is less than a biasing force provided by the biasing device when the valve controller is in the unlatched position..

14. The valve controller of claim 10, wherein the permanent magnet is ring-shaped with a central opening, wherein the moving armature is movable within the central opening of the permanent magnet.

15. The valve controller of claim 14, wherein the permanent magnet is formed of a plurality of arc-shaped segments.

16. The valve controller of claim 10 further comprising a ferrous washer disposed between the electric coil winding and the permanent magnet, wherein the coil winding and permanent magnet are magnetically coupled together.

17. The valve controller of claim 10, further comprising a retainer coupled to the permanent magnet, the retainer defining a central through orifice, with the retainer configured to receive a portion of the moving armature.

18. The valve controller of claim 17, further comprising a diaphragm coupled to the retainer, the diaphragm configured to selectively close the valve.

19. The valve controller of claim 17, wherein the armature pin is disposed in the through orifice a spaced distance from the moving armature and configured to move in the through orifice when a biasing force of the biasing device exceeds the magnetic force and the biasing device pushes the moving armature against the armature pin to extend a portion of the armature pin beyond an edge of the retainer against the diaphragm.

20. The valve controller of claim 17, wherein the moving armature has a first recess and a second recess, the first and second recesses formed on opposed axial faces of the moving armature, wherein the first recess receives a projection of the core in the latched position and wherein the second recesses receives a portion of the retainer in the latched position.
